(19) United States
(12) Patent Application Publication
(10) Pub. No.: US 2011/0081632 A1
(43) Pub. Date: Apr. 7, 2011

(54) SYSTEM AND METHOD FOR DISTRIBUTED AGILE

(75) Inventor: Swati Garg, Bangalore (IN)

(73) Assignee: WIPRO LIMITED, Bangalore (IN)

(21) Appl. No.: 12/966,006

(22) Filed: Dec. 13, 2010

Related U.S. Application Data
(63) Continuation-in-part of application No. 11/747,247, filed on May 11, 2007, now abandoned.

(30) Foreign Application Priority Data
Oct. 12, 2006 (IN) 1894/CHE/2006

(51) Int. Cl. G09B 19/00

(52) U.S. Cl. 434/118

(57) ABSTRACT

Training system and method for distributed agile learning in a team are disclosed. In one embodiment, a system includes a simulation server, a distributed Agile learning module residing in the simulation server, and two or more client servers associated with two or more team participants. The two or more client servers are communicatively coupled to the simulation server via a network. The distributed Agile learning module selectively uses combination of numeric, alphanumeric and pictorial puzzles/brain teasers and set of role play instructions upon the team participants learning theoretical understanding of the distributed Agile practices for end to end project simulation.

### RELATED APPLICATIONS

Benefit is claimed under 35 U.S.C. 120 to U.S. Non Provisional Application Ser. No. 11/747,247, entitled “A TRAINING TECHNIQUE FOR LEARNING AGILE METHODOLOGY” by inventor Swati Garg, filed May 11, 2007, which is herein incorporated in its entirety by reference for all purposes.

Benefit is claimed under 35 U.S.C. 119(a) to Indian Provisional Application Ser. No. 1894/CHE/2006 entitled “Practical training on Agile (XP) methodologies through combination of alpha-numeric and pictorial puzzles” by Swati Garg, filed on Oct. 12, 2006.

### FIELD OF THE INVENTION

The present invention generally relates to a training system and a method for use by training session participants to quickly and effectively understand and implement Agile/XP practices in Projects where the team may not be co-located. More particularly, the invention relates to a training system and method that creates end to end real life project scenarios in technologies independent manner for demonstrating and experiencing distributed Agile/Extreme Programming (XP) practices.

### BACKGROUND OF THE INVENTION

The concept of using training methods to group-train software practitioners on practices of generic software development approaches is wide spread. The group-training assists in reinforcing the concepts for suitable development approach for the success of project. One of the established software development approaches is Agile. Agile is a customer focused development approach in which customer's changing requirements are considered and implemented through small iterations of project execution. Agile approaches are driven by a set of values and principles defined and agreed through www.Agilemanifesto.org. Also, Agile is a practical and proven methodology for software project developments because of the very fact that it is instituted by software practitioners. Agile is known to be in formal existence since 2001, and many companies across the globe have derived productivity and quality benefits through the application of Agile practices.

One of the most popular Agile approach for software development is known as extreme programming (XP). Typically, XP involves developing software through several small iterations of incremental delivery. The entire project team works in close collaboration with the customer. Generally, XP is performed using the 12 core XP practices named as Metaphor, Onsite customer, Planning Game (which can include activities, such as Release Plan, Iteration Plan, Visual control, and Daily standup meeting), Small Release, Sustainable Pace, Simple Design, Re-factoring, Test First Development, Pair-Programming, Coding Standards, Continuous Integration, and Collective ownership. The XP Team includes key roles, such as Customer, XP Coach, XP Programmers and Testers. The XP Team also includes some more roles, such as Project Manager, Tracker, and Consultant.

The customer's requirements in the XP projects are expressed as “Story Cards”, i.e., the story cards represent a fully implementable feature/functionality defined in the user terms. The story cards are basic building blocks for software development through XP practices. Relationship among story cards is defined by the business rules of the customer's business domain. Several story cards that relates to each other can form different sub systems that can influence the final system ultimately. The story cards are primarily written by customer and well understood by the project team before implementation. The customer may provide several story cards to start the project; however, the team can limit the number of story cards to a smaller number for implantation in any given iteration by selecting high priority story cards. The customer can also change or add story cards at the end of any iteration.

In current software business scenarios the possibility of geographically distributed teams is increasing rapidly. Such teams find it further hard to implement Agile/XP practices in their project scenarios.

Available methods for training teams on Agile/XP practices address the need with varying degrees of completeness and efficacy. Existing training systems and methods are not equipped to simulate the distributed Agile project scenarios. The existing training methods do not cover all 12 core XP practices in seamless manner. Further the existing training methods do not encompass XP practices such as Metaphor, Test First Development, Simple Design, Re-factoring, Coding Standards and Continuous Integration in technologies independent manner. Furthermore, the existing training systems and methods for XP practices expect considerable technical acumen in training session participants.

### SUMMARY OF THE INVENTION

System and method for distributed agile are disclosed. In one aspect, the training system is a simulation using networked computers under client-server mode to enable the training method that provides end to end project scenarios simulation for demonstrating and experiencing the Agile/XP practices for co-located and distributed teams. In the present disclosure 12 different XP practices are covered seamlessly by an innovative gaming method to simulate end to end real life project scenarios that is driven using more than one role play instructions set to be followed by session participants over pre defined time boxed iterations. A novel combination of numeric, alphanumeric and pictorial puzzles is applied to create technologies independent simulation of end to end agile project scenario for co-located and distributed teams. In the form of a gaming session, the present training method enables a software project team to adopt Agile/XP practices that make them focused toward delivery of high quality software to their customer while accommodating changing needs of the customer and reducing the time taken to market for final deliverables.

This disclosure demonstrates and reinforces learning on challenges and solutions for the distributed Agile/XP practices in an experiential, retrospective and fun driven manner. It is novel for the following key reasons:

It covers at least 12 XP practices in a seamless manner. It takes care for specific learning attributed to challenges and solution for distributed Agile Team.

There is no existing training system and method that encompasses following XP practices without emphasis on particular technologies:
1. Metaphor
2. Test First Development
3. Simple Design
4. Re-factoring
5. Coding Standards
6. Continuous Integration

This training system and method do not depend on any specific technological background of participates hence participants of different profiles such as Project Managers, Architects, Developers and Testers can participate and learn with same efficiency. This training is implemented as a Training System using networked computers under client-server mode, wherein the complete training system involves very little cost because the standard personal computers can be deployed as the server and clients to run the training system and method for repeated training sessions.

### BRIEF DESCRIPTION OF THE DRAWING

A more detailed understanding of the invention may be had from the following description of exemplary embodiments to be understood in conjunction with the accompanying drawing wherein:

FIG. 1 illustrates a basic block diagram of a training system as a simulation server, according to one embodiment.

FIG. 2 illustrates an exploded view of the distributed Agile learning module of FIG. 1, according to one embodiment.

FIG. 3 illustrates a high level transactional block diagram of the training system to enable the training, according to one embodiment.

FIG. 4 is an example flow chart that illustrates the training for session participants, according to one embodiment.

FIGS. 5-7 illustrate story cards with necessary attributes for suitability to training, according to one embodiment.

FIG. 8 illustrates a final solution obtained by one of the primary groups that participated to execute the training process, according to one embodiment.

The drawings described herein are for illustration purposes only and are not intended to limit the scope of the present disclosure in any way.

### DETAILED DESCRIPTION

System and method for distributed agile are disclosed. A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

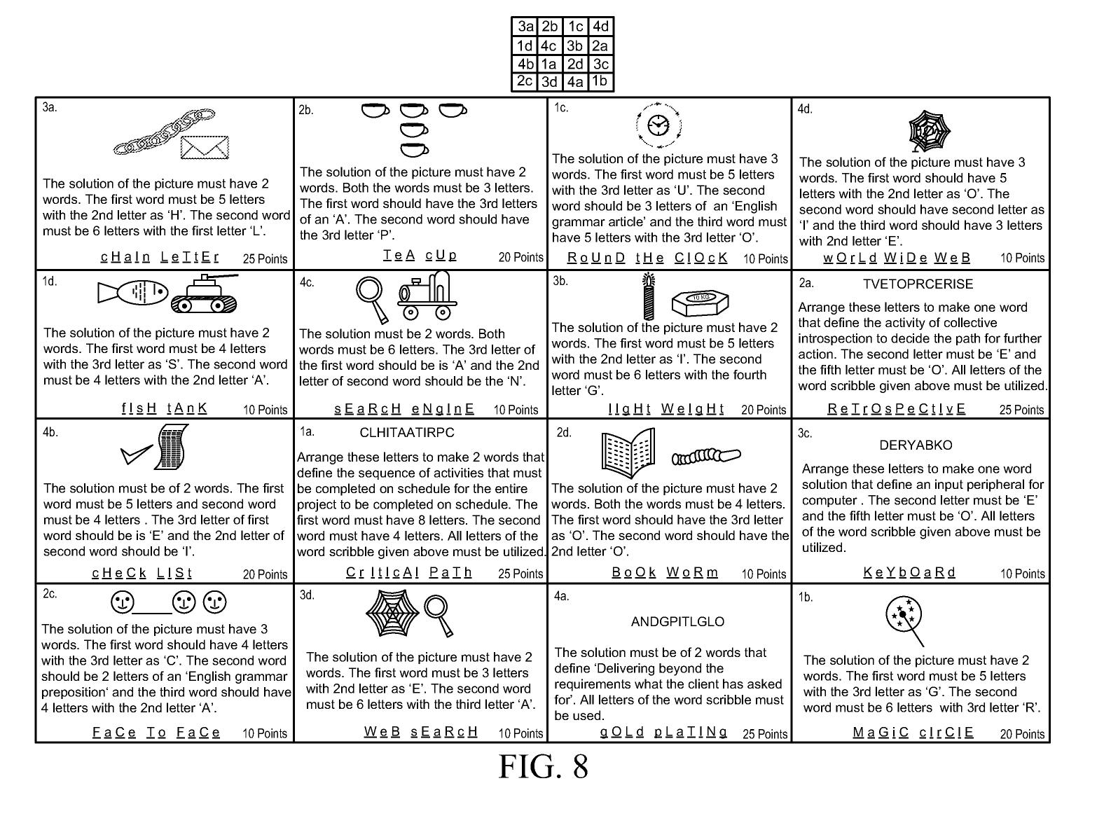

The terms ‘training process’, ‘Agile Learning Module’, ‘Distributed Agile Learning Module’, ‘Exponential Power Game’ and “XP game” are used interchangeably throughout the document for end to end real life project simulation. The term ‘application’ refers to a desired outcome of the present training process. For example, the desired outcome of the present training process is as shown in FIG. 8. The term ‘code’ refers to a solution for story card.

In the following example, training process is conducted substantially after completing the theoretical session on distributed Agile/XP practices. However, this training process can also be performed independently or differently, for those who already have good understanding of the theoretical aspects of distributed Agile/XP practices, in a separate session or by an individual study using available reading material on distributed Agile/XP practices. Detailed structure of the present subject matter is covered in the following paragraphs.

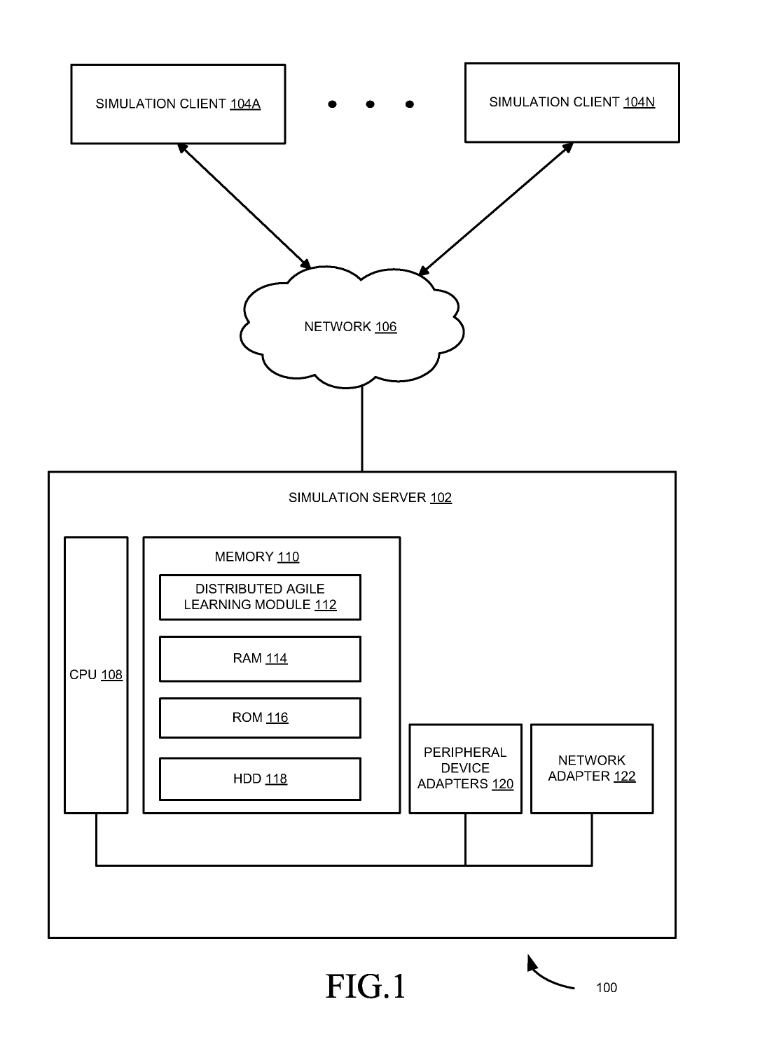

FIG. 1 illustrates a block diagram 100 of the training system as simulation server, according to one embodiment. The simulation server (102) (also refers as a training system server) includes various hardware components. Among these hardware components may be at least one central processing unit (108), at least one memory unit (110), peripheral device adapters (120), and a network adapter (122). These hardware components may be interconnected through the use of one or more busses and/or network connections.

The processing unit (108) may include the hardware architecture necessary to retrieve executable code from the memory unit (110) and execute the executable code. The executable code may, when executed by the processing unit (108), cause the processing unit (108) to implement at least the transaction of training steps to enable the training participants in learning distribute Agile/XP practices. In the course of executing code, the processing unit (108) may receive input from and provide output to one or more of the remaining hardware units.

The memory unit (110) may be configured to digitally store data consumed and produced by the processing unit (108). Further, the memory unit (110) includes the distributed Agile learning module 112. The memory unit (110) may also include various types of memory modules, including volatile and nonvolatile memory. For example, the memory unit (110) of the present example includes Random Access Memory (RAM) 114, Read Only Memory (ROM) 116, and Hard Disk Drive (HDD) memory 118. Many other types of memory are available in the art, and the present specification contemplates the use of any type(s) of memory in the memory unit (110) as may suit a particular application of the principles described herein. In certain examples, different types of memory in the memory unit (110) may be used for different data storage needs. For example, in certain embodiments the processing unit (108) may boot from ROM, maintain nonvolatile storage in the HDD memory, and execute program code stored in RAM.

The hardware adapters (120, 122) in the simulation server (102) are configured to enable the processing unit (108) to interface with various other hardware elements, external and internal to the simulation server (102). For example, peripheral device adapters (120) may provide an interface to input/output devices to create a user interface and/or access external sources of memory storage. A network adapter (122) may provide an interface to the network (106), thereby enabling the transmission of data to and receipt of data from other devices on the network (106), including the simulation clients (104A-N).

The above described embodiments with respect to FIG. 1 are intended to provide a brief, general description of the suitable computing environment in which certain embodiments of the inventive concepts contained herein may be implemented. As shown, the computer program includes the distributed Agile learning module 112 for training distributed Agile/XP practices to the team participants.

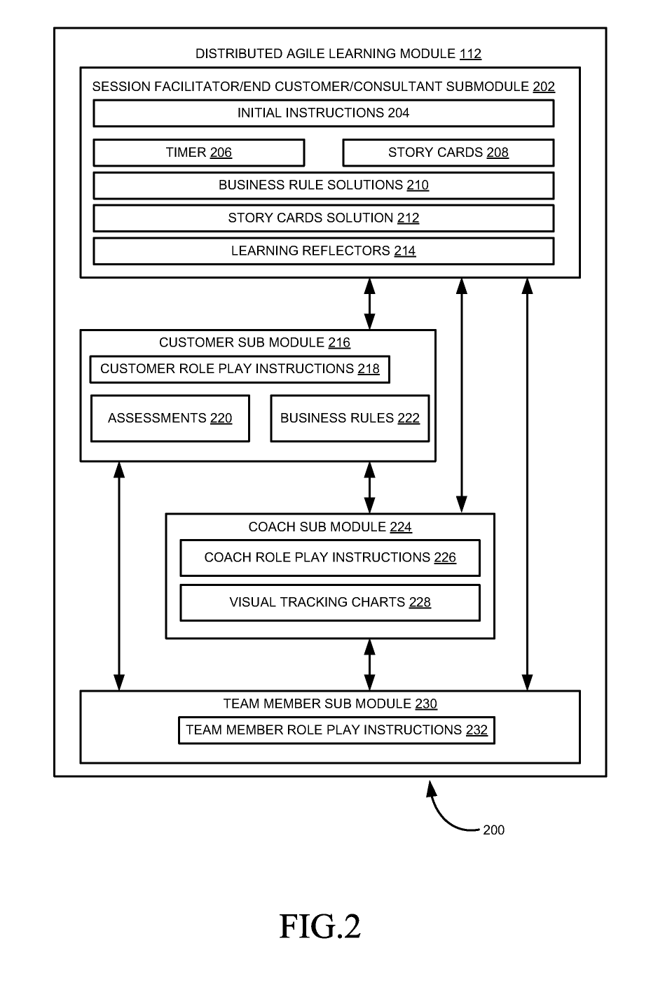

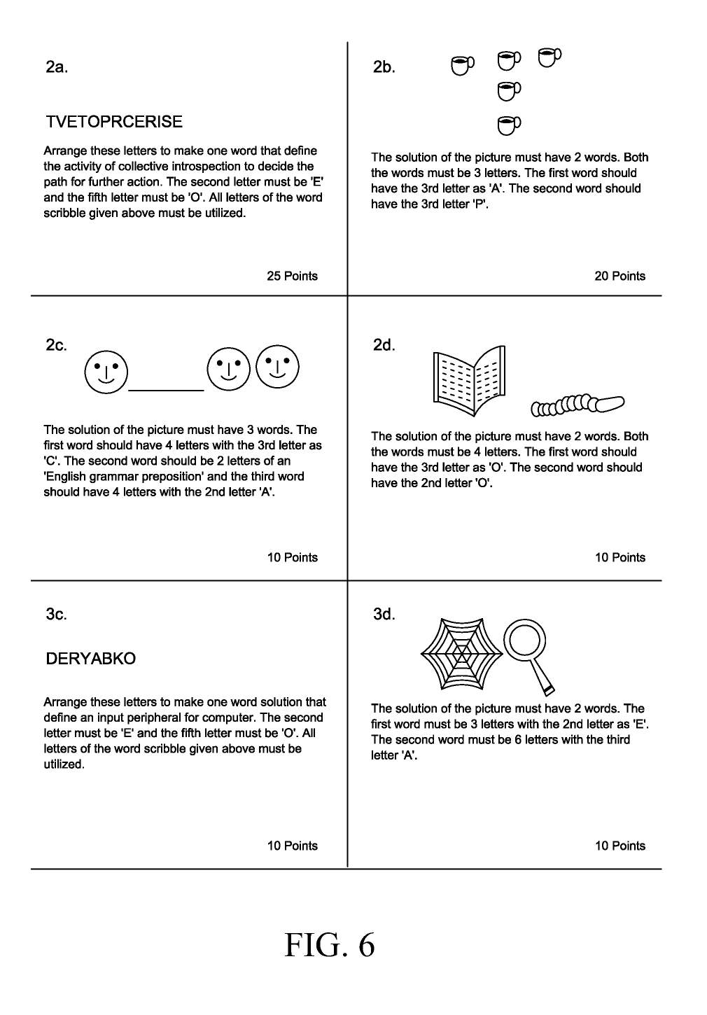

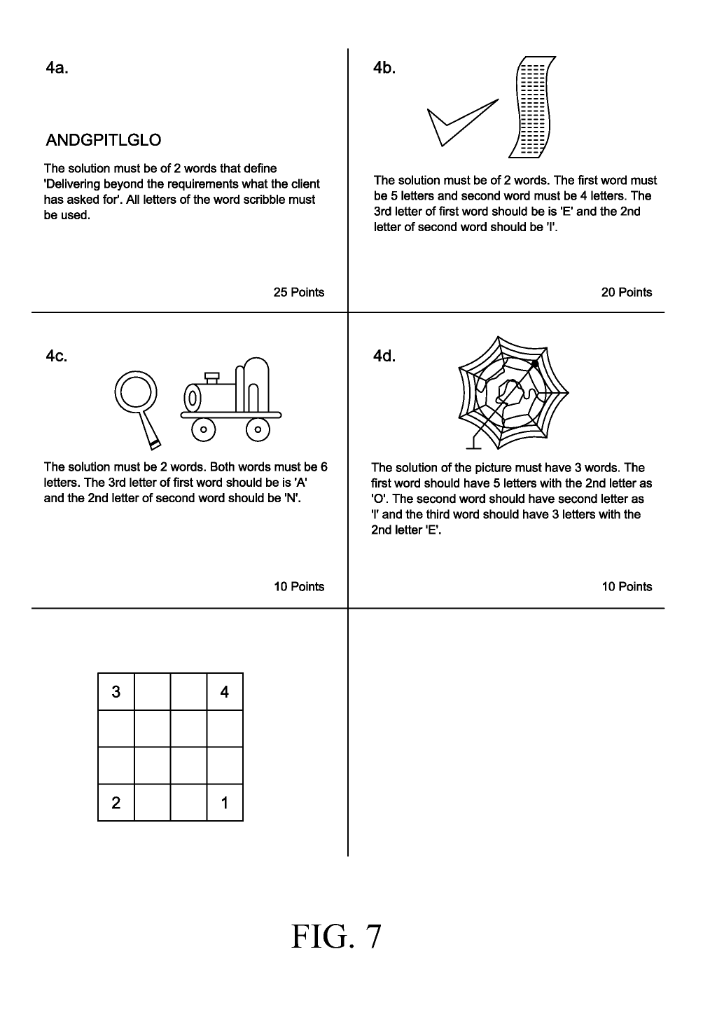

For example, the distributed Agile learning module 112 may be in the form of instructions stored on a non-transitory computer-readable storage medium. An article includes the non-transitory computer-readable storage medium having the instructions that, when executed by a physical computing device (e.g., the simulation server 102), cause the computing device to perform the one or more methods described in FIGS. 2-8.

FIG. 2 illustrates an exploded view 200 of the distribute Agile learning module 112 of FIG. 1, according to one embodiment. The distributed Agile learning module 112 resides in the simulation server 102. It is further structured as inter-dependent sub-modules as Session Facilitator/End Customer/Consultant sub-module 202, Customer sub-module 216, Coach sub-module 224 and Team Member sub-module 230.

The Session Facilitator/End Customer/Consultant sub-module 202 contents primary block components for data and information on the initial instructions 204, timer 206, story cards 208, business rules solution 210, story cards solutions 212 and learning reflections 214. Data and information from these block components of this sub-module 202 is exchanged internally and externally with block components of other sub-modules based on training steps in process flow 400.

The Customer sub-module 216 contents primary block components for data and information on customer role play instructions 218 with business rules 222 and assessments 220. Data and information from these block components of this sub-module is exchanged internally and externally with block components of other sub-modules based on training steps in process flow (400).

The Coach sub-module 224 contents primary block components for data and information on coach role play instructions 226 and visual tracking charts 228. Data and information from these block components of this sub-module 224 is exchanged internally and externally with block components of other sub-modules based on training steps in process flow (400).

The team member sub-module 230 contents primary block components for data and information on team member role play instructions 232. Data and information from these block component of this sub-module 230 is exchanged externally with block components of other sub-modules based on training steps in process flow (400).

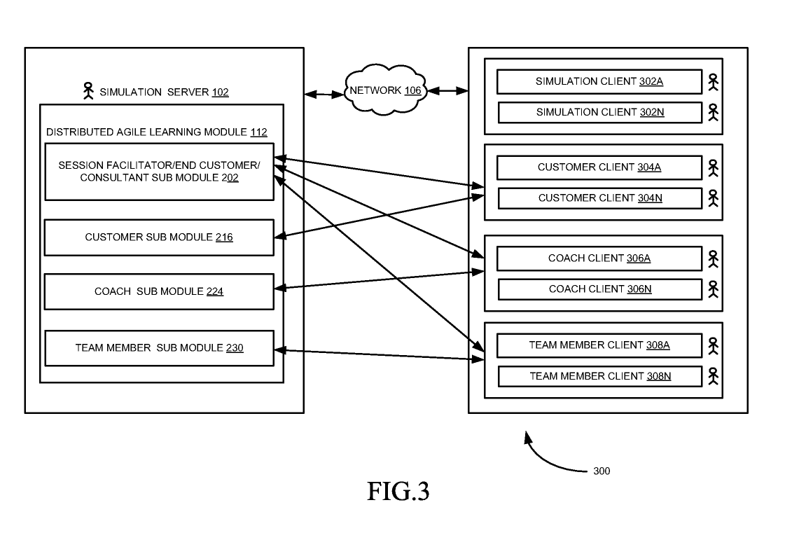

FIG. 3 illustrates the operational diagram (300) of training system in client server mode. The training system server or simulation server computer 102 is operated by at least one session faculty/facilitator. It hosts the distributed Agile learning module 112. The Session Facilitator/Consultant sub-module 202 provides initial instructions and unified time boxed iterations to all the client side computers that are operated by one of more training session participants in more than one role play. The customer sub-module 216 provides a distinctive set of role play instructions to customer role play client computers 304A-N, and the Session Facilitator/End Customer/Consultant sub-module 202 provides story cards to customer role play client computers 304A-N to subsequently pass on to other client computers that represented their respective primary group members. The customer sub-module 216 shares and retrieves assessment data from customer role play client computers 304A-N for score keeping of respective primary groups.

The coach sub-module 224 provides a distinctive set of Agile coach role play instructions to coach role play client computers 306A-N. Further the coach sub-module 224 shares and retrieves the visual tracking charts from coach role play client computers 306A-N. The Team member sub-module 230 provides a distinctive set of Agile team member play instructions to team member role play client computers 308A-N.

FIG. 3 illustrates an operational training system 300 for enabling the training for session participants to demonstrate and experience distributed Agile/XP practices. Further the training process uses an end to end project simulation based on novel combination of numeric, alphanumeric and pictorial puzzles to establish business rules and story cards that need to be solved based on instructions on role plays for co-located and distributed teams, according to one embodiment. Final solution created on execution of the training process is regarded as the application developed by respective primary groups participating as project team working on the end to end project simulation, according to one embodiment. Particularly, FIG. 3 illustrates a training system server 102 including a distributed Agile learning module 112, and a plurality of training system clients (e.g., 302A-N) connected to the simulation server 102 via the network 106. The network 106 can include but not limited to Internet, Ethernet, and Intranet. In another example, the network 106 can include local area network (LAN), metropolitan area network (MAN), wide area network (WAN), wireless LANs and WANs, and so on. Further, each of the simulation clients' is associated with at least one participant. Furthermore, the plurality of training system client 302A-N includes at least three simulation clients. Each simulation client 302A-N may be a physical computing device such as a computer, mobile, personal digital assistant (PDA) and so on. Further, the simulation clients 302A-N can act as customer clients 304A-N, coach clients 306A-N, and/or team member clients 308A-N.

Further, the server computer hosts solutions for business rules implementation and respective story cards as part of The Session Facilitator/End customer/Consultant sub-module 202. This sub-module from simulation server or server computer 102 facilitates consultant role play by routing solutions for specific story cards or business rule implementation on need basis to respective primary groups as on the client computers 302A-N. Server computer 102 is used to supply and retrieve back the data of assessments by customer client computers 304A-N and the visual tracking chart status of respective coach's client computers 306A-N. Story cards can be changed and shared for any forthcoming iteration using the server computer 102.

Respective member of the customers role play receive their role play instructions on client computers 302A-N connected via the network 106 to server that hosts the distributed Agile learning module 112. The client computers 302A-N are used by customer role plays for recording the assessment data of their respective primary team's performance on execution of the training process and communicating the assessment data back to server through the customer sub-module 216. Customers consent for consultants' involvement via the consultant sub-module of server side to support the primary team is also routed through the customer client computers 304A-N.

Further client computers are associated with primary group participants for executing the training process based on the role play instructions for Agile coach and Agile teams. Each of these client computers 308A-N are used by at least one or more members of primary team to design the high level architecture as per the business rules shared by the customer role plays. During iterations the solutions of respective story cards are devised and implemented on these client computers 308A-N. The solutions are shared with customer role plays using network 106 for distribute teams scenario. The visual tracking charts are created and maintained on client computers 306A-N by the Agile coach role play. All the real time changes on client computers are shared to the main server 102 that hosts the distributed Agile learning module 112 for aggregation of activities and learning during the entire period of training process execution.

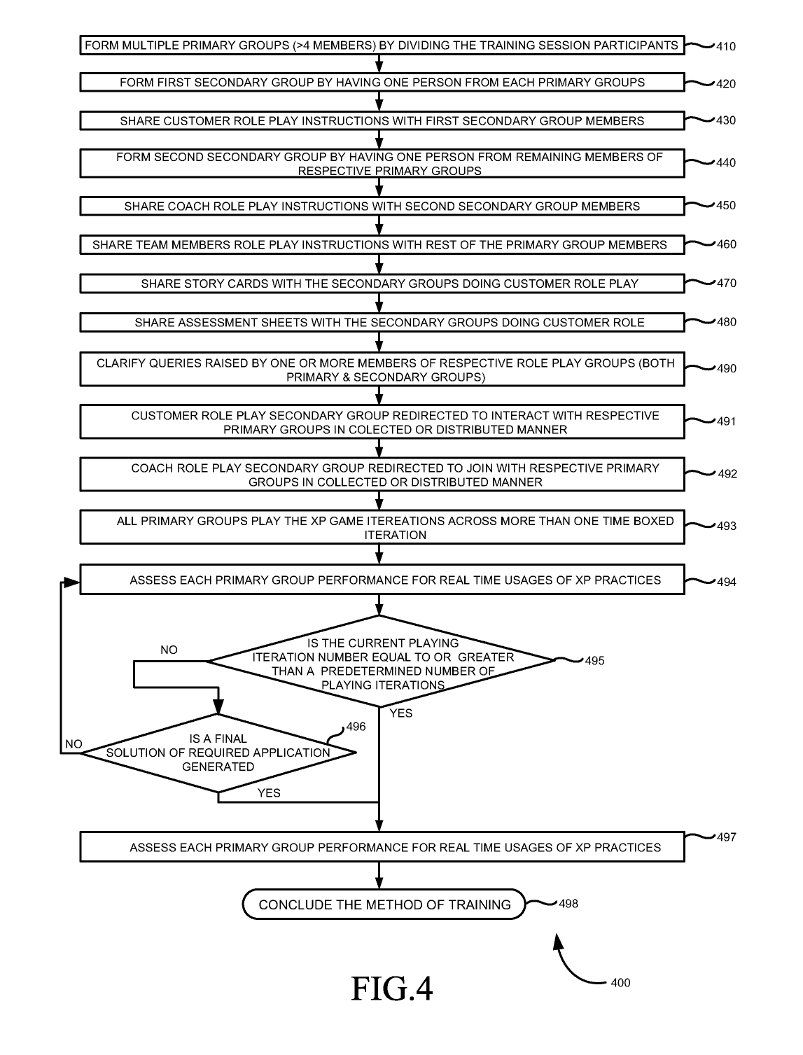

With specific reference to the exemplary process 400 illustrated in FIG. 4, the flowchart process and decision elements are associated with a corresponding reference number. For details on the decision elements, the following explanation is provided:

The training process 400 begins where the initiation instructions from the Session Facilitator/Consultant sub-module 202 residing in training system server 102 are shared with training participants to form multiple primary groups. A step 410 all the participants (the number of participants in one session may vary) of training session are divided into smaller primary groups of equal size (for example, 6 to 8 members per group) to initiate the execution of training process. Primary group members use one of more client computers, where the each primary group is associated with one or more client computers.

In these embodiments, participants in primary and secondary groups play a predetermined number of roles. In these embodiments, the predetermined number of roles is substantially less than the number of training team participants. The predetermined number of roles can include roles, such as customer, end customer, Agile coach, training session facilitator, consultant, Agile team and so on. Each primary group may have 3 role plays to be performed by its members. Exemplary role play can be namely a customer (played by one member of each primary group), an XP coach (played by different members of the primary group for different iteration. Each member within the primary group may be given a chance to act as the XP coach other than the member playing as the customer) and the XP team (played by all members of the primary group. In some embodiments, the role of XP Manager and Tracker is assumed with the member who plays as the XP coach. The training session facilitator (can be one or more individuals) plays the role of a consultant on demand.

At step 420, instruction from the Session Facilitator/Consultant sub-module 202 residing in training system server 102 are shared with primary groups to spare one member to be part of a secondary group to prepare as separate role play group that is different than role play of remaining members of the primary groups. In some embodiments, after the primary groups are formed to run the training process, the respective primary group's members who are assuming to play different role requested to come out of their primary group to form a secondary group. Each of the primary group (without customer role play member) is also called XP team in these embodiments. At step 430, the customer role play instructions from the Customer sub-module 216 residing in training system server 102 are shared using the network 106 to one or more client computers (e.g., customer clients 304A-N of clients 302A-N) that are operated by customer role play secondary group members. In these embodiments, the faculty/instructor of the training workshop enables the customer role-play preparation by providing the following artifacts over networked client computers to respective members within the customer role play secondary group. In some embodiments, direct solution for project simulation is not included in these instructions. If the members playing as customer are curious to know the actual solutions for the sake of understanding then the training session facilitator can show them some example of the solution keys described in later sections.

Following illustrates a set of role play instructions that is shared by the training session facilitator to each member of the customer role play group using the networked client computers connected by training system server using the customer sub-module 216 residing inside in distributed Agile learning module 112:
a. Training facilitator is the end customer/business user for your organization, who has defined the business rules and story cards to be implement through the real life project simulation called XP Game.
b. In case if you need some clarification on instructions then revert to the training session facilitator.
c. XP game will be played through 10 minutes iterations to simulate the Agile project scenarios. Indication on iteration start time and end time will be provided by the training session facilitator.
d. d. You will be provided some story cards and the assessment sheet before signal on starting the first iteration of XP game. The XP game session will start at a defined time indicated by training facilitator. At that point in time you should get in touch with the team that represents your primary group/XP team Share 5-6 story cards to the XP team members.
e. Start communicating about the prime requirements to XP team by expressing that these stories that need to be implemented are interconnected based on certain business rules.
f. Use metaphor: mention that that business rules are similar to ‘Sudoku’ puzzles.
g. Communicate the following business rules:
   i. Rule 1: Arrange 4 numbers (1, 2, 3, and 4) in the fields of an 4×4 array in such a manner that no number repeats in a row, in a column or in each block of 4 fields in each quadrant.
   ii. Rule 2: Starting from lower right corner of the 4×4 array, all the numbers must fall in corners in clockwise manner.
   iii. A copy of the picture below can be shared to explain the above said business rules and to facilitate the architecture/high level design guidance that follows ‘Sudoku’ as metaphor.

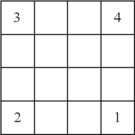

iv. Rule 3: For the central square of fields. All numbers must follow anticlockwise pattern and no number must repeat on any diagonal.

v. Rule 4: Add letters (a, b, c, d) to each number placed within the array in such a way that each number gets association with each letter only once (For example 1a, 1b, 1c,1d) and no letter repeats in a row, column or block of 4 fields in each quadrant.

vi. On successful implementation of above mentioned business rule the team must be able to arrive at interdependent unique value for each field in the 4×4 array of Sudoku alike puzzle.

vii. The unique value within each field are direct representation of its relationship with story cards that has corresponding labels and tags such as 1b, 3d, 2a and so on.

viii. The story cards would relate to each other in terms of their positioning in the 4×4 array based on the business rules implementation.

ix. Some story cards can be added modified or removed at the end of sometime boxed iterations during the execution period of XP game.
h. Communicate with XP team to convey that that this project simulation is called XP (Exponential Power) game, as the business user want them to identify the diagonal with the highest ‘Exponential Power’ starting from any one of the corner of 4×4 array solution that is designed to implement the business rules. Where in the numbers arranged on one of the diagonal must fetch the highest value when arranged in exponential order starting from one of the 4 corners [For example: (((2)³)⁴)^{1:} It may or may not be the highest value though].
i. At the end of successful architecture iteration based on the business rules implementation team should be able to revert on which one is diagonal is highest ‘Exponential Power’ diagonal. Identification of high power diagonal will be the qualification criterion for XP team's progress toward story cards implementation iterations.
j. Do not share following details unless the XP team reverts to you with relevant questions to find the information that they would need for successful execution of the project simulation as XP game.
k. If they ask then communicate about your priority. Inform them that each story card has a unique identifier ((1a, 1b . . . 4c, 4d—the letters in each story represents the priority of story. ‘a’ for priority 1 stories, ‘b’ for priority 2 stories, ‘c’ and ‘d’ for lower priority).
l. If the team asks the basis for priority then clarify that it is based on business value that is defined by the end customer.
m. If they ask that who is the end customer then dairy that end customer is an educational institute that wants to use the outcome for teaching purpose.
n. If team asks then inform them about following coding standards:
   Follow the alternate case letters (For Example: AlTeRnAtE).
   The story card located at top left corner must start with small case letter.
   Continue to follow the alternate case letter across the row. (For Example: SoLuTiOnOnE, sOlUtIoNtWo).
   Based on the last letter of the right hand side solution of the row above, the left hand side solution of the subsequent row must follow the alternate case letter, (For Example: if the right hand side solution of the row above is SoLuTiOnFoUr then the next row's left hand side solution must be written as ‘SoLuTiOnFiVe).
o. If team asks then clarify them about writing the test cases. Tell them that all ‘Should be’ and ‘Must be’ condition have to be tested. Given an example that if the story card is as below:
‘Picture’: the solution must be 2 words. The first word must be 5 letters and second word must be 4 letters. The 3rd letter of first word should be is ‘E’ and the 2nd letter of second word should be ‘I’.
The test case for this story is ‘_{——}E_{——’ ‘I}_{——}’.
p. If the team ask for the help of consultant then you can agree to provide the consultant help free of cost for 75% of planned work is done during the iteration, otherwise consultant involvement will incur a 50% loss of points against that activity. Except architecture phase do not agree for consultant, rather tell the team to de-scope. Provide consultant only if they have failed to achieve the solution for particular story cards in 2 iterations.
q. Do not accept the story that is not integrated in the business rules 4×4 array. Do not allow unsolved story card to be placed in the grid.
Continue to monitor/track the teams' activities: Especially coach's activities and assign the points in the assessment sheets based on the performance.

At step 440, instruction from the Session Facilitator/Consultant sub-module 202 residing in training system server 102 are shared with primary groups to identify one member to be part of another secondary group to prepare as separate role play group which is different than role play of remaining members of the primary groups.

At step 450, the Agile coach role play instructions from the Coach sub-module 224 residing in training system server 102 are shared using the network 106 to one or more client computers (e.g., coach clients 306A-N of clients 302A-N) that are operated by the Agile coach role play secondary group members. In these embodiments, the faculty/instructor of the training session enables the coach role-play preparation by providing the instructions over networked client computers to respective members within the coach role play secondary group.

Following illustrates a set of role play instructions that is shared by the training session facilitator to each member of the Agile coach role play group using the networked client computers connected by training system server using the coach sub-module 224 residing inside in distributed Agile learning module 112:

Coach instructions specific to planning phase and architecture iteration
a. Ensure that team communicates with customer to understand the look and feel of story card.
   Inform/notify the team to listen to customer.
   As soon the customers explanation is over then inform the team to get clarification on how priority1, priority2 and lower priority is depicted by customer.
   Inform the team to seek clarifications on what basis customer has decided the priority.
   Inform the team to seek clarifications about the coding standards to solve these stories.
   inform the team to seek clarifications on how to test these stories.
   Inform the team to not to jump on solution of story cards at this point in time.
b. Ensure that the team clarifies doubts of business rules.
   Ask the customer about metaphor. The metaphor is ‘Sudoku’ or ‘Kenken’ because the customer will use this as guiding principle for implementation of business rules.
   Ask the team to check with customer that what will take if they are not able to achieve the architecture within the time box. Suggest team to negotiate for consultants help.
c. Guide the team to make the high level plan and estimate for implementation in iterative approach.
   Ask them to plan that first of all they must device the number grid (1, 2, 3, 4 number Sudoku) and then they must go about filling in the letters in Sudoku manner (a, b, c, d).
   Keep them away from planning too much in advance. Tell that we should be able to handle combination of 4+/− story per iteration.
d. Guide the team to utilize the remaining time of planning phase for creating the architecture.
e. Guide the team for using simple design approach during architecture activities.
   Ask the team to first create the number grid
   Then suggest them to start filling the letters using the simple order of a, b, c, d in the first row.
   Later the complexity will evolve by itself due to game rule of Sudoku.
   Ask the team to find out which of the diagonal is highest ‘Exponential power’. It is achieved when the numbers arranged on one of the diagonal fetch the highest number when arranged in exponential order starting from any corner [For example: (((2)³)⁴)¹].
f. Based on your performance to guide the XP team, your team will be assessed by customer of your team. The scores will be shared across the teams by the training session facilitator to indicate the best XP team. Refer to the team member's instructions for understanding of assessment pattern and score.

Coach instructions specific to story cards implementation iterations:
a. Guide team to stay focused on iteration planning Suggest them to pick story cards based on customer priority and technical relationship. Suggest them to include estimation for story card analysis, writing test case, writing answers by following coding standards, continuous integration and re-factoring.
   Inform the team to use the technical relationship of stories within a row, so that each row will show up as a subsystem ready.
   Inform the team to inform customer that due to technical dependencies team has chosen a different set of stories than all high business value ones.
b. Follow visual tracking: Visual tracking charts will be shared with you before starting the iteration. You need to ensure that visual tracking mechanism is followed. Use the story board/visual tracking chart to show the movement of story cards. (In the starting all story cards will be in the Backlog queue. As soon as the story card is picked for solution then it is considered to be in ‘In Progress Queue’ unless the testing and integration is completed. The story card is moved in to the ‘Release’ queue for customer acceptance at the end of iteration/time box).
   Suggest the team to de-scope if they have chosen too much to do in the current iteration.
c. Follow daily stand up meeting: Stand-up meeting is called every three minutes. Since first 2 minutes of iteration has gone in estimation, your first call of stand up meeting will be at 5^{th} minute. Similarly the next stand up meeting will occur at 8^{th} minute. Effectively you will conduct 2 daily stand-up meetings in each of the implementation iteration. (Participants: 1 person from each pair and Agile coach). The team members reply 3 questions: What has he/she done so far? (Answer: Story card number: Started, in progress) What does he/she plans to do? ((Answer: Story card number: In progress, finish). What is stopping/road block (Answer: Need help from Consultant).
d. Use metaphor to guide the team. The metaphor is Sudoku.
e. Promote pair programming. Ask two people to work together to have online review of coding standards (The coding standard: All solutions must be written in alternate case letter across the row. (For Example: SoLuTiOnOnE, sOlUtIoNtWo)).
f. Promote test first development: Suggest the team to write the test case before they write the solution for story card.
g. Promote adherence to coding standards.
h. Facilitate re-factoring: Mostly there will be instances of deviation from coding standards. Suggest the team to re-factor at regular intervals to maintain the good quality of solutions (code) for implemented story cards.
i. Promote collective ownership by suggesting everybody to participate in re-factoring.
j. Promote continuous integration. As soon as a story card solution is ready, ensure that it is joined to other available story cards in the 4×4 array.
   k. Based on your performance to guide the XP team, your team will be assessed by customer of your team. The scores will be shared across the teams by the training session facilitator to indicate the best XP team. Refer to the team member's instructions for understanding of assessment pattern and score.
l.

At step 460, the Agile team role play instructions from the Team member sub-module 230 residing in training system server 102 are shared using network 106 to one or more client computers (e.g., team member clients 308A-N of clients 302A-N) that are operated by the Agile team member role play by remaining members of primary groups. In these embodiments, the faculty/instructor of the training session enables the XP team role -play preparation by providing instructions over networked client computers to respective members within the primary group.

Following illustrates a set of role play instructions that is shared by the training session facilitator to each member of the Agile coach role play group using the networked client computers connected by training system server using the team member sub-module 230 residing inside in distributed Agile learning module 112:

In some embodiments, the primary groups members (other than the customer role) are supplied with following instructions to prepare as ‘XP teams’ and ‘XP coaches’ at a broad level:
a. Each team will have 1 member playing the role of customer, who will also maintain score of team.
b. Time boxed iterations of 10 minutes will be followed for all activities during the project-XP game. Initially 5 minutes will be given for kick-off session with customer of your team. Subsequent 10 minutes will be the planning phase; next 10 minutes will be the architecture iteration after which the story cards implementation iterations will start. Each iteration starts with estimation (Approximately 2 minutes) and ends with acceptance by customer (Approximately 1 minute).
c. On completion of 10 minutes iterations, the session facilitator will induce 5 minutes change over. Change over minutes will be used for explanation and understanding of activities with respect to the real life project execution scenarios. Change over minutes can also be used for rotation of the coach role play.
d. Team must clarify questions to customer if they need clarity on story cards or test cases or coding standards. Team will be writing test case for respective story cards.
e. If team is not able to achieve the architecture or solve a story then they can seek for external consultant's help (Customer will wear the hat of consultant—team may incur some cost for external help. They must settle the cost with customer during the release planning).
f. Team must participate in daily standup meeting. Stand-up meeting will be called every three minutes. (Participants: 1 member from each pair of team members and Agile coach). The team members reply 3 questions: What has s/he done so far? (Answer: Story card number: Started, in progress) What does s/he plans to do? (Answer: Story card number: In progress, finish). What is stopping/road block (Answer: None, need help from consultant)
g. The coach needs to ensure that visual tracking chart is followed. Use the story board/visual tracking chart to show the movement of story cards. (In the starting all story cards will be in the Backlog queue. As soon as the story card is picked for solution then it is considered to be in ‘In Progress Queue’ unless the testing and integration is completed. The story card is moved in to the ‘Release’ queue for customer acceptance at the end of iteration).
h. Team must keep the customer informed about all decisions that they make.
i. Following is an example scoring model that can be used to score during the game:

| S. No. | Description | Score |
|---|---|---|
| 1 | Achieving the architecture | 100 |
| 2 | Solving priority 1 stories | 25 |
| 3 | Solving priority 2 stories | 20 |
| 4 | Solving stories below priority 2 | 10 |
| 5 | Meeting iteration's story selection logic | 25 |
| 6 | Coach-iteration criteria implemented (per line | 10 |
| | item) | |

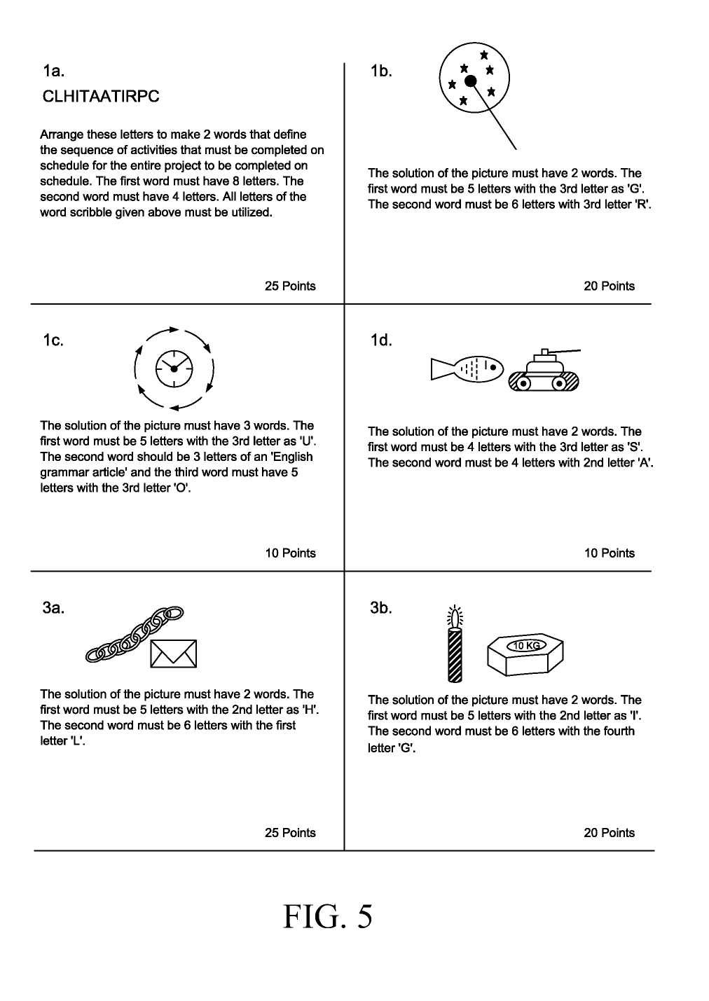

At step 470, some story cards are shared by the training session facilitator to each member of the customer role play group using the networked client computers connected by training system server 102 using the end customer sub-module 216 residing inside in distributed Agile learning module 112. The story cards are further shared across client computers 302A-N from customer role play groups to the XP team member clients 308A-N. In some embodiments, the story cards are predefined as illustrated in FIGS. 5-7. As shown in FIGS. 5-7, the story cards are presented as partially editable puzzles. Some intentional mistakes are introduced in these story cards to trigger the dialogues between XP team and customer. The priority of each story card can be defined with the help of labels ‘a’, ‘b’, ‘c’ and d’. Wherein the label ‘a’ can represent the highest priority. In some embodiments, the story cards are added, modified and removed at the end of any iteration during the execution of training process.

At step 480, Assessment sheets are shared by the training session facilitator to each member of the customer role play group using the networked client computers 304A-N connected by training system server using the customer sub-module 216 residing inside in distributed agile learning module 112.

Following illustrates a set of assessment sheets and score criteria for respective groups that can be shared, modified and commonly viewed using the networked computers of the training system.

### Assessment Sheet for Coach's Performance During the Planning Phase/Architecture Iteration:

| | | |
|---|---|---|
| | Criteria to score - 10 point if the | Score (10 or |
| | criterion is met, ‘zero’ if the criterion is | Zero for each |
| S. No. | not met | criterion) |

| | |
|---|---|
| 1 | He/she is ensuring that team |
| | communicates with customer to |
| | understand the look and feel of story card. |
| 2 | He/she is ensuring that the team clarifies |
| | doubts of business rules. |
| 3 | He/she is guiding the team to make the |
| | high level plan and estimate for |
| | implementation in iterative approach. |
| 4 | He/she is guiding team to utilize the |
| | remaining time for creating the |
| | architecture. |
| 5 | He/she is guiding the team for using |
| | simple design approach. |

### Assessment Sheet for Team's Performance During the Planning Phase/Architecture Iteration:

| | | Score |
|---|---|---|
| S. No. | Criteria to score | (Tick as applicable) |
| 1 | Architecture achieved | 100 points |
| 2 | Consultant's help after 75% of work done | 75 points |
| 3 | Consultant's help before 75% of work | 50 points |
| | done | |
| 4 | Coach's score | |

### Assessment Sheet for Coach's Performance During the Stories Implementation Iterations:

| | | |
|---|---|---|
| | Criteria to score - 10 point if the | Score (10 or |
| | criterion is met, ‘zero’ if the criterion is | Zero for each |
| S. No. | not met | criterion) |

| | |
|---|---|
| 1 | He/she is ensuring that team focus on |
| | iteration planning. |
| 2 | He/she is ensuring that the team follows |
| | visual tracking. |
| 3 | He/she is guiding the team to follow daily |
| | stand up meeting. |
| 4 | He/she is guiding team towards pair |
| | programming. |
| 5 | He/she is guiding the team for promoting |
| | coding standards. |
| 6 | He/she is facilitating re-factoring |
| 7 | He/she is promoting collective ownership. |
| 8 | He/she is promoting test first |
| | development. |
| 9 | He/she is using metaphor. |
| 10 | He/she is promoting continuous |
| | integration |

### Scoring Criterion for Different Priority of Story Cards:

| S. No. | Description | Score |
|---|---|---|
| 1 | Solving priority 1 stories | 25 |
| 2 | Solving priority 2 stories | 20 |
| 3 | Solving stories below priority 2 | 10 |
| 4 | Meeting iteration's story selection logic | 25 |

### Assessment Sheet for Team's Performance During the Story Cards Implementation Iterations:

| S. No. | Criterition to score | Score |
|---|---|---|
| 1 | Number of priority 1 stories completed | X * 25 |
| | (X) | |
| 2 | Number of priority 2 stories completed | Y * 20 |
| | (Y) | |
| 3 | Number of stories below priority 2 | Z * 10 |
| | completed (Z) | |
| 4 | Consultant's help after 75% of work done | Just tick |
| 5 | Consultant's help before 75% of work | Give half points |
| | done | |
| 6 | Coach's score | Sum |
| 7 | Iteration's story selection logic met | 25 |

At step 490, doubts and queries raised by one or more participants of the respective primary and secondary groups are clarified by the training session facilitator. The networked computers of training system help to facilitate the communication. In some embodiments, members of the customer role play secondary group can seek clarifications or help on about insight on end solution of business rules or story cards. In these embodiments, the session facilitator provided solutions by retrieving information from the consultant sub module 202 residing with the distributed Agile learning module 112 hosted on server computer of the training system.

At step 491, the training process redirects the customer role play secondary group to dismantle and revert to interact with respective primary groups in distributed manner using physically remote location of client computers configurations in one of the embodiments.

At step 492, the training process redirects the Agile coach role play secondary group to dismantle and revert to join with respective primary groups in collocated manner using collocated type of client computers configurations in one of the embodiments.

At step 493, all primary groups as XP team along with their respective coach and customer kick off the project simulation as XP game through interactions as per the role play, understanding of business rules ad story cards through time boxed iterations controlled by timer of the session facilitator sub module of the distributed Agile learning module 112 within the training system server 102.

At step 493, in some embodiments, the session facilitator provided solutions as consultant role play to XP teams by retrieving information from the consultant sub module residing with the distributed Agile learning module 112 hosted on server computer 102 of the training system.

Following is the illustrative set of solutions for business rules solutions and story cards that are used in some embodiments.

The solution key for possible numeric 4×4 array that can be created by the XP team based on the business rules as defined in some embodiments.

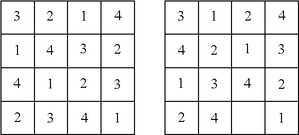

Wherein the highest Exponential Power value diagonal is T starting from the left hand side top corner by fetching the exponential value of (((3)⁴)²)¹ or (((3)²)⁴)¹=6561.

### The Other Diagonal Values are as Below:

The diagonal starting from upper right corner brings values of (((4)³)¹)² or (((4)¹)³)²=4096.
The diagonal starting from lower left corner brings values of (((2)¹)³)⁴ or (((2)³)¹)⁴=4096.
The diagonal starting from lower right corner brings values of (((1)²)⁴)³ or (((₁)⁴)²)³=1.

It can be seen that there is a prominent difference in the number in the ‘grey’ cells. If the team fails to devise alphanumeric solution based on the business rule explained by the customer then they can ask for the help from the training facilitator who is playing the role of consultant. The consultant can offer the one of the solution listed based on the ‘digit’ corresponding to the ‘grey’ cell in team's numerical solution.

Below are the example keys of most preferred solutions for devising the alphanumeric 4×4 array that would work as the architecture for the overall solution of the training process.

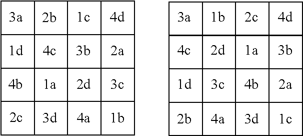

However, it is possible to create several other combinations of alphabetical characters within purview of the business rules shared by the customer to the team; two such example solutions are listed below:

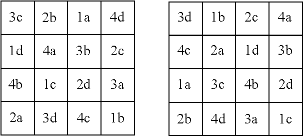

In some embodiments, if the team using the networked computers succeed in designing an alphanumeric 4×4 array that is valid according to the business rules defined by the customer where the solution is not same as the any one of the preferred solutions as listed above then the Team and the coach losses the points that are awarded against the simple design practice.

Following are solutions keys for story cards shown in FIGS. 2-4:
1a. Critical path
1b. Magic circle
1c. Round the clock
1d. Fish tank
2a. Retrospective
2b. Tea cup
2c. Face to face
2d. Book worm
3a. Chain letter
3b. Light weight
3c. Keyboard
3d. Web search
4a. Gold plating
4b. Check list
4c. Search engine
4d. World wide web

At step 494, each primary group (XP team) and its coach's performance is assessed by the customer and recorded in an associated computer for reference to assessment data over the execution period of project simulation as XP game. In some embodiments, the member playing as customer for respective primary group performs assessment at the end of every iteration.

At step 495, the process 100 determines whether the current playing iteration number is equal to or greater than a predetermined number of playing iterations. In some embodiments, the session facilitator ensures that the time boxed iterations (10 minutes per iteration in the given example of this invention) are followed by all participants. The session facilitator observes the activities performed by the each primary group (XP team). At the end of iterations the training session facilitator explains the learning achieved by each primary group to reinforce the experiential learning of distributed Agile project simulation as XP game.

Based on the determination at step 495, the training process 400 goes to step 496 and 497 and concludes the training the team participants if current playing iteration number is equal to or greater than the predetermined number of playing iterations. The process 400 goes to step 496 if the current playing iteration number is not equal to the predetermined number of playing iterations. At step 496, the process 400 determines whether a final solution of XP game project simulation is generated by at least one team Based on the determination at step 496, the process goes back to step 493 and repeats steps 493-495—unless pre determined number of iterations are completed. In some embodiments, the XP teams continue to play the XP game (project simulation) until one of the primary groups achieves the end solution of the XP game. FIG. 8 shows sample end solution that can be achieved XP game as part of this training process. In some embodiments, the session facilitator stops further execution if no team is able to achieve the end solution however all the learning are well conveyed to participants through a few run of iterations in the given/available time to run the XP game (project simulation) as part of the training process.

Based on the positive determination at step 495 and 496, the process goes to step 497 to share the consolidated learning reflector and assessment scores. At step 498 the training process concludes. Upon concluding the XP game (project simulation), participants will feel confident based on experiential learning provided through this training process. A complete run through this training process enables session participants to get seamless understanding of all XP practices to work as part of collocated or distributed agile project teams.

Following tables outline the example learning achieved by the training session participants upon undergoing the above mentioned training process. Table-1: Lists learning offered based on listed XP practices (using the given example of this invention) while playing the first iteration (planning phase) and the second iteration (architecture iteration) activities of XP game (project simulation) as part of this training process. The listed activities of XP game (project simulation) in the following table-1 offer a better understanding of corresponding XP Practices:

| | | XP game (project simulation) Activity as part of training |
|---|---|---|
| S. No. | XP Practice | process |
| 1 | Onsite | One dedicated participant plays role of ‘Onsite Customer’. He/She |
| | Customer | is made available with the group (team) on full time basis to |
| | | provide required inputs, answer the questions, change/add story |
| | | cards and negotiate for consultants' availability. |
| | | In case of distributed location of customer it becomes important to |
| | | find alternate channels of communication (such as messenger, |
| | | phones and frequent visits) and coordination to ensure project |
| | | success. |
| 2 | Planning | Team at high level understands the details (business rules and the |
| | Game | story cards) shared by customer and decides road map to go |
| | (Release Plan) | forward. |
| | | In case of distributed team the planning gaps are bridges by real |
| | | time channels of communication such as live meeting and |
| | | messengers. |
| 3 | Small Release | The fixed time boxed iterations of 10 minutes duration are defined |
| | | and used during the XP game (project simulation) to its |
| | | completion. It does not get affected based on teams distributed |
| | | locations if there is network connectivity. |
| 4 | Metaphor | In this example of XP game (project simulation) the team uses |
| | | ‘Sudoku’ as metaphor. This metaphor helps the team to devise the |
| | | high level architecture. Then team picks the story cards for the |
| | | iterations in a manner that relates to ‘Sudoku’ rules as defined by |
| | | the customer. The team continues to follow the ‘Sudoku’ as |
| | | guiding principle while working towards completion of XP game |
| | | (project simulation) It does not get affected based on teams |
| | | distributed locations |
| 5 | Simple | The simplest approach is followed to create the architecture based |
| | Design | on the business rules defined by customer. In case of distributed |
| | | team the design challenges are bridges by real time channels of |
| | | communication and collaboration such as live meeting and |
| | | messengers. |
| 6 | Collective | Everybody in the team participates to create the architecture based |
| | ownership | on the business rules defined by customer. In case of distributed |
| | | team gaps in this practice are bridges by rotating team members |
| | | across different locations. |
| 7 | Sustainable | The team participates in estimation and decides number of |
| | Pace | required iterations. The team tries to achieve the plan in iteration |
| | | time. Overwork and under utilization is avoided. In case of |
| | | distributed team gaps in this practice are bridges by sharing |
| | | concerns and finding resolutions during release planning and |
| | | iteration planning. |

TABLE 2
Learning is offered towards listed XP practices (using the given example of this
invention) while playing the story cards implementation iterations' activities
of XP game (project simulation) as part of this training process. In other words,
the listed activities of XP game (project simulation) offer understanding of
corresponding XP Practices in the table below.

| | | XP game (project simulation) Activity as part of training |
|---|---|---|
| S. No. | XP Practice | process |
| 1 | Onsite | One dedicated participant plays role of ‘Onsite Customer’. |
| | Customer | He/She is made available with the group (team) on full time |
| | | basis to provide required inputs, answer the questions, |
| | | change/add story cards and negotiate for consultants' |
| | | availability. |
| | | In case of distributed location of customer it becomes important |
| | | to find alternate channels of communication (such as messenger, |
| | | phones and frequent visits) and coordination to ensure project |
| | | success. |
| 2 | Planning | The team makes a high level execution plan (Release Plan) in |
| | Game | customers presence based on the inputs provided during the first |
| | (Release | iteration (Planning phase). |
| | Plan, | Team members pick story cards to implement in the iteration. |
| | Iteration | They estimate the time/effort required for implementation of |
| | Plan, Visual | selected story cards. |
| | control, | Visual control: the coach uses the story board to show the |
| | Standup | movement of story cards (In the starting all story cards will be |
| | Meeting) | in the Backlog queue. As soon as the story card is picked for |
| | | solution then it is considered to be in ‘In Progress Queue’ unless |
| | | the testing and integration is completed. The story card is moved |
| | | in to the ‘Release’ queue for customer acceptance at the end of |
| | | iteration). |
| | | Stand-up meeting is called every three minutes. (Participants: 1 |
| | | person from each pair and Agile coach). The team members |
| | | reply 3 questions: What has he/she done so far? (Answer: Story |
| | | card number: Started, in progress) What does he/she plans to |
| | | do? ((Answer: Story card number: In progress, finish). What is |
| | | stopping/road block (Answer: Need help from Consultant) |
| | | In case of distributed team the planning gaps are bridges by real |
| | | time channels of communication such as live meeting and |
| | | messengers. |
| 3 | Small | The fixed time boxed iterations of 10 minutes duration are |
| | Release | defined and used during the XP game (project simulation) to its |
| | | completion. It does not get affected based on teams distributed |
| | | locations if there is network connectivity. |
| 4 | Simple | The simplest approach is followed to create the architecture |
| | Design | based on the business rules defined by customer. In case of |
| | | distributed team the design challenges are bridges by real time |
| | | channels of communication and collaboration such as live |
| | | meeting and messengers. |
| 5 | Refactoring | It is triggered due to the coding standards that call for inputs |
| | | from evolving solution of neighboring stories. In case of |
| | | distributed team the refactoring challenges are bridges by |
| | | limiting the refactoring to specific locations ad by rotating the |
| | | team members across different locales. |
| 6 | Metaphor | In this example of XP game (project simulation) the team uses |
| | | ‘Sudoku’ as metaphor. This metaphor helps the team to devise |
| | | the high level architecture. Then team picks the story cards for |
| | | the iterations in a manner that relates to ‘Sudoku’ rules as |
| | | defined by the customer. The team continues to follow the |
| | | ‘Sudoku’ as guiding principle while working towards |
| | | completion of XP game (project simulation). It does not get |
| | | affected based on teams distributed locations |
| 7 | Pair | The team works on each story card by pairing up. Pairs rotate |
| | Programming | from iteration to iteration as one of them has to move out to take |
| | | up the Agile coach role. One pair finishes 1 story card before |
| | | working on next story card. If a pair can not resolve a card then |
| | | they ask other team members and finally they decide to take |
| | | help from consultant. In case of distributed team the Pair |
| | | programming challenges are bridges by limiting the Pair |
| | | programming to specific locations ad by rotating the team |
| | | members across different locales. |
| 8 | Collective | Everybody in the team participates to re-factor the story cards |
| | ownership | within the architecture and ensures that they do not break |
| | | anything else. In case of distributed team gaps in this practice |
| | | are bridges by rotating team members across different locations. |
| 9 | Sustainable | The team participates in estimation and decides number of |
| | Pace | required iterations. The team tries to achieve the plan in iteration |
| | | time. Overwork and under utilization is avoided. In case of |
| | | distributed team gaps in this practice are bridges by sharing |
| | | concerns and finding resolutions during release planning and |
| | | iteration planning. |
| 10 | Coding | All solutions (code) for implementing respective story cards |
| | Standards | must be devised through proper coding standards. Customer |
| | | defines the coding standards to the team. Alternate case letters |
| | | are used as the Coding Standards. It does not get affected based |
| | | on teams distributed locations |
| 11 | Testing | All ‘must be’ and ‘Should be’ conditions within story cards are |
| | | utilized for writing the test case. The test case are devised based |
| | | on thorough understanding of story cards and solution (Code) is |
| | | devised against the test case. In case of distributed team the |
| | | testing challenges are bridges by expending the testing to all |
| | | locations ad by rotating the team members across different |
| | | locales. |
| 12 | Continuous | The story card in iteration is considered for scoring only if the |
| | Integration | story card for which the solution is devised, is integrated (placed |
| | | at the appropriate position in the business rule's alphanumeric |
| | | 4 × 4 array. on immediate and continuous basis. In case of |
| | | distributed team the challenges are bridges by expending the |
| | | Continuous Integration to all locations. |

Overview of an embodiment of the training process: XP game as aforesaid is an end to end project simulation that is used to coach the software practitioners and leaders by novel combination of numeric, alphanumeric/pictorial puzzles and brain teasers for learning distribute agile/XP practices. This is a fun driven, experiential and retrospective training process which helps participants to identify the weak areas in their approach towards adopting the Agile (XP) practices before the real life software project execution. The training process based on XP game (project simulation) is designed keeping in mind the team work involved, creative thinking and other human aspects that enable the ‘discipline in chaos’ behavior for a successful software project execution for collocated and distributed teams. The training process based on XP game (project simulation) takes about 2 hours practically to implement with a participant group and encompasses all twelve XP practices within. The XP game (project simulation) t is designed in a technology independent manner while maintaining a simple and close vision of the technology world. Even though the above training process using XP game (project simulation) is explained with reference to learning XP practices, one can envision using the above Training process to learn practices of other Agile approaches, such as Scrum, Feature Driven Development, Dynamic System Development Methods, Agile Unified Process, EVO, and Crystal Methods.

Market leaders in Agile implementation/consulting and training have so far conducted training focused on only specific aspects such as planning, estimation, collaboration and communication. It does not appear that all 12 XP practices within a single training process are covered selectively using alphanumeric/picture puzzles and timed iterations have been implemented by other market leaders in technology-independent manner. Through disclosed of this invention as technology-independent approach using novel combination of numeric, alphanumeric/pictorial puzzles and brain teasers to create end to end project scenarios enables participants from entirely different or no technical background/s to participate and effectively learn XP practices.

The details on key structural differences of the present subject matter the training process based on XP game (project simulation) as compared to the existing training processes (available in several internet sites, class room trainings offered by different vendors and subject matter books) are shown in the table below:

| | | | How is it | Is it a new | | |
|---|---|---|---|---|---|---|
| | | | handled in the | way of | | |
| S. | Structural difference | | present training | implementa- | In what sense | |
| No. | criteria | | process? | tion? | is it unique? | Remarks |
| A | Coverage of all 12 | | Inventor has | Yes | It is the only | Other training |
| | practices of Extreme | | used novel | | training | processes from |
| | Programming in a | | combination | | process that | different |
| | single training | | and | | covers all 12 | vendors have |
| | process. | | overlapping | | XP Practices in | only focused |
| | | | thread of | | a technology | on ‘planning |
| | | | alpha-numeric | | independent | game’, ‘short |
| | | | and pictorial | | manner | releases’ and |
| | | | puzzles/brain | | | ‘onsite |
| | | | Teasers to | | | customer’ |
| | | | create a close | | | practices. |
| | | | connection of | | | There is no |
| | | | all 12 practices | | | single or |
| | | | of Extreme | | | combination of |
| | | | Programming | | | training |
| | | | within XP | | | processes |
| | | | game (project | | | available for |
| | | | simulation) of | | | covering all XP |
| | | | single training | | | practices. |
| | | | process. | | | Only, there |
| | | | | | | could be some |
| | | | | | | training |
| | | | | | | processes to |
| | | | | | | cover the |
| | | | | | | concepts on |
| | | | | | | ‘Pair |
| | | | | | | Programming’, |
| | | | | | | ‘Re-factoring’ |
| | | | | | | and |
| | | | | | | ‘Continuous |
| | | | | | | Integration’ in |
| | | | | | | a specific |
| | | | | | | technology |
| | | | | | | segment. |
| B | Distributed agile | | The present | Yes | a client-server | No existing |
| | project simulation for | | training | | based training | training system |
| | end to end project | | process using | | system enables | and process |
| | scenario | | XP game | | distributed | provides hands |
| | | | (project | | agile project | on and |
| | | | simulation) | | scenarios by | technologies |
| | | | creates | | the training | independent |
| | | | distributed | | process that | simulation of |
| | | | agile scenarios | | uses XP game | distributed |
| | | | in different | | (project | agile project |
| | | | proportions by | | simulation) | for learning |
| | | | physical | | | through |
| | | | restructuring of | | | experience. |
| | | | role play | | | Impact of |
| | | | locations. | | | distribute team |
| | | | Real time | | | in agile project |
| | | | solutions are | | | scenario is |
| | | | provided for | | | clearly realized |
| | | | experiential | | | and solutions |
| | | | learning for | | | to address he |
| | | | distributed | | | impacts are |
| | | | Agile projects. | | | internalized by |
| | | | | | | participants. |
| | | Brief | How is it | Is it a new | | |
| | | description | handled in the | way of | | |
| | XP | of the XP | present training | implementa- | In what sense | |
| B | Practice | Practice | process? | tion? | is it unique? | Remarks |
| 1 | Metaphor | All | In this training | Yes | In the XP | No example is |
| | | stakehold- | process the XP | | game (project | found of an |
| | | ers should | game (project | | simulation), | existing |
| | | have | simulation) the | | the customer | training |
| | | common | participants | | and team use a | modules that |
| | | vision and | group/team | | metaphor such | can closely |
| | | mission | uses | | as ‘Sudoku’. | exhibits the |
| | | toward the | ‘Sudoku’ ® as | | Throughout the | ‘Metaphor’ |
| | | delivery. | metaphor to | | execution of | practice of |
| | | They | represent the | | the training | ‘Extreme |
| | | should be | business rules. | | process, all | Programming’. |
| | | able to | This metaphor | | stakeholders | |
| | | relate to | helps the team | | can experience | |
| | | the whole | to devise the | | the advantage | |
| | | picture in | high level | | of the | |
| | | their | architecture. | | ‘Mataphor’ | |
| | | respective | Then the team | | practice within | |
| | | purview. | picks story | | Extreme | |
| | | | cards for the | | Programming. | |
| | | | iterations in a | | The metaphor | |
| | | | manner that | | of ‘Sudoku’ for | |
| | | | relates to | | XP game | |
| | | | ‘Sudoku’ rules. | | project | |
| | | | The team | | simulation | |
| | | | continues to | | helps the team | |
| | | | follow | | to devise the | |
| | | | ‘Sudoku’ as | | high level | |
| | | | the guiding | | architecture. It | |
| | | | principle while | | enables the | |
| | | | working | | customer to | |
| | | | towards | | verify the | |
| | | | completion of | | architecture | |
| | | | the XP game | | devised by the | |
| | | | (project | | team. Then the | |
| | | | simulation). | | team picks the | |
| | | | | | story cards for | |
| | | | | | the iterations in | |
| | | | | | a manner that | |
| | | | | | relates to | |
| | | | | | metaphor rules. | |
| | | | | | The team | |
| | | | | | continues | |
| | | | | | using guidance | |
| | | | | | from the | |
| | | | | | metaphor | |
| | | | | | ‘Sudoku’ | |
| | | | | | throughout the | |
| | | | | | training | |
| | | | | | process. | |
| | | Brief | How is it | Is it a new | | |
| | | description | handled in the | way of | | |
| | XP | of the XP | present training | implementa- | In what sense | |
| | Practice | Practice | process? | tion? | is it unique? | Remarks |
| 2 | Test | The unit | All ‘must be’ | Yes | The Test First | No example is |
| | First | test cases | and ‘should be’ | | Development | found of an |
| | Develop- | must be | conditions | | defined in XP | existing |
| | ment | generated | within story | | game (project | learning |
| | | before | cards (A fully | | simulation) is | module that |
| | | developing | implementable | | independent of | exhibits a |
| | | the code | feature/function- | | any software | technology |
| | | to ensure | ality defined | | technology. In | independent, |
| | | that the | in the user | | this training | close |
| | | application | terms) are | | process the XP | relationship |
| | | under | utilized for | | game (project | with the ‘Test |
| | | development | writing the test | | simulation) is | First |
| | | is | case. The test | | designed in a | Development’ |
| | | thoroughly | cases are | | way that | practice of |
| | | tested, | devised based | | enforces the | ‘Extreme |
| | | starting | on a thorough | | participants to | Programming’. |
| | | from the | understanding | | write the test | |
| | | unit | of story cards | | cases before | |
| | | testing | and, the | | devising the | |
| | | level. | solution | | solutions for | |
| | | | (Code) is | | respective | |
| | | | devised against | | story cards. | |
| | | | the test case. | | | |
| 3 | Simple | Architec- | The approach | Yes | The Simple | No example is |
| | Design | ture should | to create and | | Design | found of an |
| | | be made | maintain the | | practice of | existing |
| | | modular | ‘simple design’ | | Extreme | learning |
| | | and design | is introduced | | Programming | module that |
| | | should be | through the | | covered as part | exhibits |
| | | kept | instructions | | of XP game | technology |
| | | simple to | that that are | | project | independent, |
| | | meet the | sent to the | | simulation is | close |
| | | require- | groups/teams | | independent of | relationship |
| | | ments of | (who are | | any software | with the |
| | | given | executing the | | technology. | ‘Simple |
| | | iteration | training | | The pointers | Design’ |
| | | only. | process using | | are provided in | practice of |
| | | | XP game | | terms of | ‘Extreme |
| | | | (project | | written | Programming’. |
| | | | simulation) | | instructions to | |
| | | | prior to start of | | participating | |
| | | | the iteration. | | groups/teams. | |
| | | | | | With the help | |
| | | | | | of the | |
| | | | | | instruction, the | |
| | | | | | respective | |
| | | | | | group/team | |
| | | | | | moves toward | |
| | | | | | leveraging the | |
| | | | | | simple design | |
| | | | | | concept of | |
| | | | | | Extreme | |
| | | | | | Programming. | |
| 4 | Coding | The | All solutions | Yes | The coding | No example is |
| | Standards | project | (code) for | | standards | found of an |
| | | team must | implementing | | defined in XP | existing |
| | | not | respective | | game (project | training |
| | | deviate | story cards | | simulation) are | process that |
| | | from | must be | | independent of | exhibits |
| | | coding | devised | | any software | technology |
| | | standards. | through proper | | technology. | independent, |
| | | | coding | | The coding | close |
| | | | standards as | | standards are | relationship |
| | | | part of the XP | | designed to be | with the |
| | | | game (project | | simple and | ‘Coding |
| | | | simulation). | | error free | Standards’ |
| | | | Customer | | during | practice of |
| | | | defines the | | implementation. | ‘Extreme |
| | | | coding | | Clear focus | Programming’ |
| | | | standards to | | on importance | |
| | | | the team. The | | of coding | |
| | | | coding | | standards is | |
| | | | standards are | | maintained | |
| | | | written in the | | while | |
| | | | instruction | | executing the | |
| | | | sheet for | | training | |
| | | | customer. | | process using | |
| | | | | | XP game | |
| | | | | | (project | |
| | | | | | simulation). | |
| | | Brief | How is it | Is it a new | | |
| | | description | handled in the | way of | | |
| | XP | of the XP | present Learning | implementa- | In what sense | |
| | Practice | Practice | module? | tion? | is it unique? | Remarks |
| 5 | Re- | Software | It is triggered | Yes | Re-factoring is | No example is |
| | factoring | code | due to the | | triggered | found of an |
| | | should be | coding | | during the | existing |
| | | continuous- | standards- | | course of | training |
| | | ly refined | rules that call | | training | process that |
| | | across | for inputs from | | process | exhibits |
| | | iterations | evolving | | execution | technology |
| | | to increase | solution of | | using XP game | independent, |
| | | the code | neighboring | | (project | close |
| | | quality | stories in the | | simulation) in | relationship |
| | | and retain | training | | natural ways, | with the ‘Re- |
| | | maintain- | process using | | so that | factoring’ |
| | | ability. | XP game | | participants do | practice of |
| | | | (project | | not loose from | ‘Extreme |
| | | | simulation). | | coding | Programming’. |
| | | | | | standards-rules | |
| | | | | | while | |
| | | | | | delivering fast | |
| | | | | | solutions | |
| | | | | | against | |
| | | | | | iterative | |
| | | | | | implementation | |
| | | | | | of the story | |
| | | | | | cards. | |
| 6 | Continu- | Any new | The story in | Yes | The | No example is |
| | ous | piece of | iteration is | | Continuous | found of an |
| | Integra- | code | considered for | | Integration | existing |
| | tion | written | scoring only if | | defined in XP | training |
| | | should be | the story card | | game project | process that |
| | | immediate- | for which the | | simulation is | exhibits |
| | | ly | solution is | | independent of | technology |
| | | integrated | devised is | | any software | independent, |
| | | and tested | integrated | | technology. | close |
| | | to ensure | (placed at the | | The integration | relationship |
| | | that it does | appropriate | | mechanism | with the |
| | | not break | position in the | | defined in XP | ‘Continuous |
| | | anything | business rule's | | game (project | Integration’ |
| | | else, or | alphanumeric | | simulation) | practice of |
| | | else, the | 4 × 4 array on | | enables the | ‘Extreme |
| | | solution | an immediate | | participating | Programming’ |
| | | should be | and continuous | | teams to learn | |
| | | made | basis in this | | through | |
| | | available | training | | experience of | |
| | | immediate- | process using | | problems and | |
| | | ly. | XP game | | loss in quality | |
| | | | (project | | due to late | |
| | | | simulation). | | integration i. n | |
| | | | | | the current | |
| | | | | | training | |
| | | | | | process | |
| | | Brief | How is it | Is it a new | | |
| | | description | handled in the | way of | | |
| | XP | of the XP | present training | implementa- | In what sense | |
| | Practice | Practice | process? | tion? | is it unique? | Remarks |
| 7 | Collec- | Everybody | Base on the | Yes | Unique | The ‘Collective |
| | tive | in the | business rules | | because | ownership’ |
| | owner- | team must | shared by the | | challenges and | practice of |
| | ship | take | customer as | | solution for | ‘Extreme |
| | | ownership | part of XP | | this XP | Programming’ |
| | | of | game (project | | practice can be | may be |
| | | complete | simulation), | | experienced in | covered in a |
| | | success | everybody in | | distributed | technology |
| | | and | the team | | agile project | independent |
| | | failure. | participates to | | scenarios using | fashion within |
| | | They | create the | | XP game | other available |
| | | should | architecture. | | (project | training |
| | | ensure that | Also | | simulation) in | processes |
| | | they do | everybody in | | different | However it is |
| | | not break | the team | | proportions by | presented in a |
| | | anything | participates to | | physical | different way |
| | | else while | re-factor the | | restructuring of | through XP |
| | | making | story cards | | role play | game (project |
| | | their | within the | | locations. | simulation). |
| | | changes. | business rule's | | | |
| | | | alphanumeric | | | |
| | | | 4 × 4 array and | | | |
| | | | ensures that | | | |
| | | | they do not | | | |
| | | | break anything | | | |
| | | | else. | | | |
| 8 | Onsite | Customer | One dedicated | Yes | Unique | The ‘Onsite |
| | Custom- | being | member from | | because | Customer’ |
| | er | made | each group of | | challenges and | practice of |
| | | available | participants | | solution for | ‘Extreme |
| | | (physical- | plays the role | | this XP | Programming’ |
| | | ly) with the | of ‘Onsite | | practice can be | is covered in a |
| | | develop- | Customer even | | experienced in | technology |
| | | ment team | in case of | | distributed | independent |
| | | throughout | distributed | | agile project | fashion within |
| | | the life | locations. This | | scenarios using | other available |
| | | cycle. | role is made | | XP game | training |
| | | Customer | available with | | (project | processes. |
| | | should be | each team on | | simulation) in | However it is |
| | | able to | full time basis | | different | presented in a |
| | | provide | to provide | | proportions by | different |
| | | clarification | required | | physical | approach tin |
| | | for | clarification, | | restructuring of | the XP game |
| | | queries on | inputs, change | | role play | (project |
| | | the stories. | or add story | | locations. | simulation) as |
| | | | cards and | | | part of this |
| | | | negotiate for | | | training |
| | | | consultants' | | | process. |
| | | | availability. | | | |
| | | | The customer | | | |
| | | | can assess | | | |
| | | | team's | | | |
| | | | performance | | | |
| | | | very closely | | | |
| | | | due to | | | |
| | | | proximity. | | | |
| | | | Solutions are | | | |
| | | | implemented | | | |
| | | | to bridge the | | | |
| | | | gap in case of | | | |
| | | | distributed | | | |
| | | | teams and | | | |
| | | | customers. | | | |
| 9 | Planning | Release | Release | Yes | Unique | The ‘Planning |
| | Game | Planning: | Planning: | | because | Game (Release |
| | (Release | All stake- | Complete team | | challenges and | Planning, |
| | Planning, | holders | and the | | solution for | Iteration |
| | Iteration | participate | customer | | this XP | Planning)’ |
| | Planning) | in release | participate in | | practice can be | practice of |
| | | planning | the release | | experienced in | ‘Extreme |
| | | meeting. | planning | | distributed | Programming’ |
| | | Based on | meeting. | | agile project | is covered in |
| | | the high | Team members | | scenarios using | technology |
| | | level | pick story | | XP game | independent |
| | | estimate | cards to | | (project | fashion within |
| | | effort, the | implement in | | simulation) in | other available |
| | | team | the iteration | | different | training |
| | | arrives at a | based on | | proportions by | processes. |
| | | tentative | customer's | | physical | However it is |
| | | release | priority and | | restructuring of | presented in a |
| | | date. | technical | | role play | different |
| | | Customer | dependencies. | | locations. | approach |
| | | provides | They estimate | | | through XP |
| | | his | the time/effort | | | game (project |
| | | comments | required for | | | simulation) in |
| | | on the | implementation | | | distributed |
| | | estimates | of selected | | | team scenarios. |
| | | and re- | story cards. | | | |
| | | organizes | Solutions are | | | |
| | | the stories | implemented | | | |
| | | if | to bridge the | | | |
| | | required. | gap in case of | | | |
| | | Developers | distributed | | | |
| | | and | teams and | | | |
| | | customer | customers. | | | |
| | | jointly | | | | |
| | | prioritize | | | | |
| | | the stories. | | | | |
| | | Priority | | | | |
| | | numbers | | | | |
| | | are | | | | |
| | | attached to | | | | |
| | | the stories. | | | | |
| | | Iteration | | | | |
| | | Planning: | | | | |
| | | All stake- | | | | |
| | | holders | | | | |
| | | participate | | | | |
| | | in the | | | | |
| | | iteration | | | | |
| | | planning | | | | |
| | | meeting. | | | | |
| | | Granular | | | | |
| | | planning | | | | |
| | | is done by | | | | |
| | | the | | | | |
| | | developers | | | | |
| | | for the | | | | |
| | | iteration to | | | | |
| | | deliver the | | | | |
| | | working | | | | |
| | | functionali- | | | | |
| | | ty against | | | | |
| | | highest | | | | |
| | | value | | | | |
| | | story cards | | | | |
| | | order. | | | | |
| 10 | Small | Each time- | Time-boxed | No | Not unique | The ‘Small |
| | Releases | boxed | iterations of 10 | | | Releases’ |
| | | iteration | minutes | | | practice of |
| | | should be | duration are | | | ‘Extreme |
| | | targeted to | defined to | | | Programming’ |
| | | make a | conduct XP | | | is covered in a |
| | | release of | game project | | | technology |
| | | fully | simulation to | | | independent |
| | | tested | its completion. | | | fashion within |
| | | working | Working | | | other available |
| | | functionali- | functionality | | | training |
| | | ty of | through | | | processes. |
| | | application. | integrated | | | However it is |
| | | | story cards is | | | presented in a |
| | | | delivered in | | | different |
| | | | each iteration. | | | approach |
| | | | | | | through XP |
| | | | | | | game (project |
| | | | | | | simulation) in |
| | | | | | | distributed |
| | | | | | | team scenarios. |
| 11 | Pair | Complete | The team | Yes | Unique | The ‘Pair |
| | Program- | functionali- | works on each | | because | Programming’ |
| | ming | ty should | story card by | | challenges and | practice of |
| | | be created | pairing up. | | solution for | ‘Extreme |
| | | in such a | Pairs rotate | | this XP | Programming’ |
| | | manner | from iteration | | practice can be | is covered in a |
| | | that 2 | to iteration as | | experienced in | technology |
| | | person | one of them | | distributed | independent |
| | | work | has to move | | agile project | fashion within |
| | | together | out to take up | | scenarios using | other available |
| | | all the | the Agile | | XP game | training |
| | | time. The | coach role. | | (project | processes. |
| | | pair of | One pair | | simulation) in | However it is |
| | | people can | finishes 1 story | | different | presented in a |
| | | rotate. | card before | | proportions by | different |
| | | | working on | | physical | approach |
| | | | next story card. | | restructuring of | through XP |
| | | | If a pair can | | role play | game (project |
| | | | not resolve a | | locations. | simulation) in |
| | | | card then they | | | distributed |
| | | | ask other team | | | team scenarios. |
| | | | members and | | | |
| | | | finally they | | | |
| | | | decide to take | | | |
| | | | help from | | | |
| | | | consultant. | | | |
| 12 | Sustain- | Any | The team | Yes | Unique | The |
| | able Pace | overtime- | participates in | | because | ‘Sustainable |
| | | work or | estimation and | | challenges and | Pace’ practice |
| | | Extra time | decides | | solution for | of ‘Extreme |
| | | should be | number of | | this XP | Programming’ |
| | | discouraged | participants | | practice can be | is covered in a |
| | | to ensure | required. The | | experienced in | technology |
| | | higher | team tries to | | distributed | independent |
| | | productivity | achieve the | | agile project | fashion within |
| | | and | plan in | | scenarios using | other available |
| | | good | iteration time. | | XP game | training |
| | | quality of | Overwork and | | (project | processes. |
| | | life. | under | | simulation) in | However it is |
| | | | utilization is | | different | presented in a |
| | | | avoided. | | proportions by | different |
| | | | | | physical | approach |
| | | | | | restructuring of | through XP |
| | | | | | role play | game project |
| | | | | | locations. | simulation in |
| | | | | | | distributed |
| | | | | | | team scenarios. |

In the foregoing detailed description of embodiments of the invention, various features are grouped together in a single exemplary embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should therefore be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., if used, are merely labels, and are not intended to impose numerical requirements on their objects.

1. A method for learning distributed Agile practices, the method being executed on at least one computer including a processor and memory, the method comprising selectively using combination of numeric, alphanumeric and pictorial puzzles/brain teasers and set of role play instructions upon the team participants learning theoretical understanding of the distributed Agile practices for end to end project simulation.

2. The method of claim 1, wherein selectively using the numeric, alphanumeric and pictorial puzzles/brain teasers comprises:
combining the numeric, alphanumeric and pictorial puzzles/brain teasers to create user story cards, their correlation based on business rules that are controlled by the alphanumeric puzzles and the set of role play instructions for training.

3. The method of claim 1, wherein the Agile practices comprises Extreme programming (XP) practices.

4. The method of claim 3, wherein the XP practices selected from the group consisting of Metaphor, Onsite Customer, Planning Game, Small Release, Sustainable Pace, Simple Design, Re-factoring, Testing First Development, Pair Programming, coding Standards, Continuous Integration, and Collective Ownership.

5. The method of claim 4, wherein training the team participants in learning XP practices for generating the required application, comprises:
forming multiple primary groups using the training team participants, wherein each primary group plays a predetermined number of roles to be performed by the training team participants;
providing the set of role play instructions to each team participant playing one of the predetermined number of roles in each primary group;
providing the created user story cards to team participants from each primary group; and
executing the method through project simulation as per the set of role play instructions and business rules and the story cards iteratively by the team participants until the final solution is achieved by any one of the primary groups.

6. The method of claim 5, wherein the predetermined number of roles is substantially less than the number of training team participants.

7. The method of claim 6, wherein the predetermined number of roles includes roles selected from the group consisting of customer, Agile coach, faculty/instructor, consultant, and Agile team.

8. The method of claim 7, further comprising:
forming a separate customer role play group by using at least one team participant from each primary group to prepare differently from each of the remaining primary group team participants; and
using assessment sheets by each member in the separate customer role play group so that each team participant playing the customer role can assess their associated primary group's performance.

9. The method of claim 7, further comprising:
providing the set of role play instructions to each team participant by an associated faculty/instructor;
clarifying any doubt each team participant may have by the associated faculty/instructor; and
assessing each primary group's performance by an associated team participant playing the customer role.

10. The method as in claim 9, wherein the training team participants work in team pairs with a time-constraint including the step of rotating the training team participants in each said team pair in each iteration.

11. The method of claim 1, further comprising:
concluding the method of training team participants at the end of a predetermined number of playing iterations.

12. The method of claim 1, further comprising:
concluding the method of training team participants when a final solution of required application is generated by any of the primary group's participants.

13. The method of claim 1, further comprising:
generating a required application by any of the training team participants upon completing the method of training team participants.

14. A system for learning distributed Agile practices, comprising:
a simulation server;
a network;
a distributed Agile learning module residing in the simulation server; and
two or more client servers associated with two or more team participants, wherein the two or more client servers are communicatively coupled to the simulation server via the network, wherein the distributed Agile learning module selectively uses combination of numeric, alphanumeric and pictorial puzzles/brain teasers and set of role play instructions upon the team participants learning theoretical understanding of the distributed Agile practices for end to end project simulation.

15. The system of claim 14, wherein the distributed Agile learning module selectively combines the numeric, alphanumeric and pictorial puzzles/brain teasers to create user story cards, their correlation based on business rules that are controlled by the alphanumeric puzzles and the set of role play instructions for training.

16. The system of claim 14, wherein the Agile practices comprises Extreme programming (XP) practices.

17. The system of claim 16, wherein the XP practices selected from the group consisting of Metaphor, Onsite Customer, Planning Game, Small Release, Sustainable Pace, Simple Design, Re-factoring, Testing First Development, Pair Programming, coding Standards, Continuous Integration, and Collective Ownership.

18. The system of claim 17, wherein in training the team participants in learning XP practices for generating the required application, the distributed Agile learning module is configured to:
form multiple primary groups using the training team participants, wherein each primary group plays a predetermined number of roles to be performed by the training team participants;
provide the set of role play instructions to each team participant playing one of the predetermined number of roles in each primary group;
provide the created user story cards to team participants from each primary group; and
execute the method through project simulation as per the set of role play instructions and business rules and the story cards iteratively by the team participants until the final solution is achieved by any one of the primary groups.

19. The system of claim 18, wherein the predetermined number of roles is substantially less than the number of training team participants.

20. The system of claim 19, wherein the predetermined number of roles includes roles selected from the group consisting of customer, Agile coach, faculty/instructor, consultant, and Agile team.

21. The system of claim 20, wherein the distributed Agile learning module further enables to:
form a separate customer role play group by using at least one team participant from each primary group to prepare differently from each of the remaining primary group team participants; and
use assessment sheets by each member in the separate customer role play group so that each team participant playing the customer role can assess their associated primary group's performance.

22. The system of claim 21, wherein the distributed Agile learning module further enables to:
provide the set of role play instructions to each team participant by an associated faculty/instructor;
clarify any doubt each team participant may have by the associated faculty/instructor; and
assess each primary group's performance by an associated team participant playing the customer role.

23. The system of claim 22, wherein the training team participants work in team pairs with a time-constraint including the step of rotating the training team participants in each said team pair in each iteration.

24. The system of claim 14, wherein the distributed Agile learning module concludes the training of team participants at the end of a predetermined number of playing iterations.

25. The system of claim 14, wherein the distributed Agile learning module concludes the method of training team participants when a final solution of required application is generated by any of the primary group's participants.

26. The system of claim 14, wherein the distributed Agile learning module generates a required application by any of the training team participants upon completing the method of training team participants.

27. A non-transitory computer-readable storage medium for learning distributed Agile practices, having instructions that, when executed by a computing device cause the computing device to:
selectively using combination of numeric, alphanumeric and pictorial puzzles/brain teasers and set of role play instructions upon the team participants learning theoretical understanding of the distributed Agile practices for end to end project simulation.
